(19) United States
(12) Patent Application Publication
(10) Pub. No.: US 2002/0113370 A1
(43) Pub. Date: Aug. 22, 2002

(54) DAO board game and method of play

(76) Inventors: Jeffrey S. Pickering, Redmond, WA (US); Ben K. Van Buskirk, Point Roberts, WA (US)

Correspondence Address: GARRISON ASSOCIATES, 2001 SIXTH AVENUE, SUITE 3300, SEATTLE, WA, 981212522

(21) Appl. No.: 10/060,124

(22) Filed: Jan. 28, 2002

Related U.S. Application Data
(60) Provisional application No. 60/265,183, filed on Jan. 30, 2001.

(51) Int. Cl. A63F 3/00; A63F 13/00

(52) U.S. Cl. 273/271; 273/237; 273/288; 463/9

(57) ABSTRACT

A board game for two players, including the board, playing pieces, and method of play. The playing area comprises 16 playing positions uniformly arranged in a square grid. Each player has four playing pieces, tactilely or visually distinguishable from those of the other player. The players move their pieces in turn according to the rules of the game until one player attains one of four winning configurations defined by the rules. The game it provides a competitive board game emphasizing strategy, intelligence, and flexible tactics that is suitable for players of varying ages and physical abilities.

### CROSS-REFERENCE TO RELATED APPLICATIONS

This application claims the benefit of U.S. Provisional Application Ser. No. 60/265,183, entitled DAO BOARD GAME AND METHOD OF PLAY, filed Jan. 30, 2001.

### TECHNICAL FIELD

The invention relates to board games. In particular, this invention describes a board game for two players with one starting configuration and four possible winning configurations. Strategic movement of the playing pieces is used to achieve one of the four winning configurations. The invention includes rules and methods of play.

### BACKGROUND OF THE INVENTION

Board games have enjoyed wide popularity for many centuries as a form of recreation and entertainment in a variety of cultures. Board games combine intellectual challenge, socialization, and food for the competitive spirit, all in the context of the particular culture of the players. Board games are based upon configurations, races, chases, wars or hunts, capture or blockade, and mental concepts. Games involving movement of playing pieces over a board having a pattern, and relying on alignment or configuration of the playing pieces to determine scoring are known in the prior art. Each games involve unique components consisting of players, game board, playing pieces, movement of the playing pieces, playing time, rules, and strategy. Many different forms of board games have been invented. The players typically take turns moving pieces on a base or board. The game boards can be as simple and portable as tic-tac-toe written on a sheet of scrap paper, to very complex and not readily portable, three dimensional structures.

Some board games start with the game pieces in a fixed configuration, such as checkers, and others require the player to distribute the game pieces on the board in the course of play, with tic-tac-toe being the most simple.

A number of these games involve arranging the playing pieces adjacent to one another to form a matrix or pattern of like pieces, either longitudinally, transversely, or diagonally. For example, some board games involve the movement of playing pieces along one or more paths identified on the playing board, according to the rules of the game. Monopoly (©Parker Brothers Division of General Mills Fun Group, Inc.) and Trivial Pursuit (©Horn Abbot Ltd.) are such games. Other board games involve the movement of playing pieces by the players between playing positions, according to rules of the game. Chess, checkers, Chinese checkers, and backgammon are such games. In some games, such as Scrabble (©Production and Marketing Company), Othello (©Gabriel Industries, Inc.) and kalah, playing pieces may be distributed to the playing board by the players during the course of play; in others, such as chess, playing pieces may be removed from the playing board by the players during the course of play. Other games, such as Nim, are readily played on any horizontal surface, but are described as board games because of the character of play.

The nature of a board game is defined in part by its rules. Some games have few rules that are easily learned, like tic-tac-toe, and others have complex rules requiring extensive time and maturity to learn, like Monopoly (©Parker Brothers Division of General Mills Fun Group, Inc.). These two types of games appeal to different ages and personality types of players as a result of their rules.

While these games fulfill their respective particular cultural objectives and requirements, none of the prior art describe a competitive game that includes significant elements of the Daoist philosophy. The Daoist philosophy includes order and harmony, rejection of unnecessary violence, simplicity, inclusion, meditation, lack of concern with interim rewards, and the fine balance between defense and offense. Further, none of the prior art describe a board game that readily includes players who have sight, hand, or motor skill disabilities.

Therefore it can be appreciated that there exists a continuing need for a new and improved board game that can be quickly learned with only a few rules; that can be enjoyed by players over a broad range of skills, maturity, and competitiveness; that can be enjoyed by children, young adults, and the family; that does not involve personal aggression against an opponent by jumping, capture, or scoring; that has the nature of a puzzle played against a changing defensive configuration; that can be played in tournaments by a broad range of players; that challenges the skill of players ranging from young to old; that requires the players to anticipate the effect of future moves and placement while being both on the offensive and on the defensive; that is short enough in duration to hold the attention of a broad range of players yet capable of being repetitively played; that increases the emphasis on strategy and educational value by minimizing the element of chance; that does not require the players to learn or memorize fixed strategies like chess, instead the strategy must be ever changing and balanced to the opponent; that can be simply modified for visually and physically impaired players while retaining the game's appeal to regular players; and that the rules allow the configuration of the pieces and the board to be changed to entertain and stimulate the players.

The object of the invention is to provide the above in a simple form that is easy to make and economical to manufacture.

### DISCLOSURE OF THE INVENTION

Accordingly, the present invention is directed toward a board game meeting the above needs. An object of the present invention is to provide a simple board game with few rules, that is both challenging and interesting to a broad range of players.

A second object of the present invention is to provide a competitive board game emphasizing strategy and education, and flexible tactics.

Another object of the present invention is to provide a board game where the winning player attains a goal that is not related to jumping, capture, or scoring against an opponent.

Yet another object of the present invention is to provide a game that can be played by both able-bodied and physically impaired players.

Still another object of the invention is to provide a game that can be played in tournaments by a wide variety of ages and abilities.

A further object is to provide a board game that allows variations in the playing board and game pieces to provide players with variety in the game.

Yet another object of the invention is to provide a game that is readily adaptable for play on a computer, either as one player against the computer, or two players against each other, wherein the computer provides apparatus for the game.

The board game of the present invention provides a playing apparatus comprising a playing board and playing pieces, and a method of play therefor termed the Rules of the Game. The playing apparatus and the Rules of the Game were each developed in conjunction with the other, and the two are inseparable.

The playing board comprises a single, flat playing area with 16 playing positions laid out in a square grid pattern, four positions on each side of the square. Lines, grooves, ridges or other suitable means may be used to identify which playing positions are deemed proximate to other nearby playing positions. Each playing position is identified on the surface of the playing board by a color differing from the remainder of the board, a depression in the surface of the board, or by other suitable means.

The game is played by two players, or one player and a computer. Each player receives four identical playing pieces. Each player's playing pieces are visually or tactilely distinct from the playing pieces received by the other player. The pieces are placed in the starting pattern on the board, the first player is chosen in a manner determined by the players, and play begins.

During the course of play, each player in turn moves one of his or her playing pieces according to the Rule of the Game. A player wins the game when the player has arranged his or her playing pieces in one of four winning configurations.

The Rules of the Game define the starting configuration as an “X” with each player's pieces forming one leg of the “X” aligned diagonally from the corners. The Rules of the Game require each player to move in any “open” direction, including diagonally. A player cannot jump over other pieces or move to a playing position that is already occupied. Each move must be in a straight line as far as possible until the piece being moved reaches the end of the playing area or another piece.

The Rules of the Game define the winning configurations as (i) forming a straight line with all of a player's pieces (diagonal does not count); (ii) occupying the four corners of the board at the same time; (iii) arranging all of the player's pieces into a square; and (iv) when a playing piece of one player is blocked in a corner by the playing pieces of the other player.

Alternative embodiments of the playing pieces include all tactilely and visually distinctive characteristics of shape, color, and texture. The playing pieces may be different colors, such as red, blue, white, gold, and silver. The playing pieces may be different shapes, such as a Buddha, totem pole, ball, and crystal. The characteristics of the playing pieces lend themselves to variations including being representative of themes to make the game more appealing to players of certain interests, groups, or cultures. For visually and physically impaired players, an alternative embodiment of the playing pieces includes tactile or audible marking to identify which player the pieces belong to, including but not limited to different sizes of the same piece configuration, sound generating apparatus in the piece, and raised markings on the piece. Further, for visually and physically impaired players, an alternative embodiment of the playing board includes tactile markings of the playing positions, including but not limited to holes that can be easily felt or seen by the impaired players.

Alternative embodiments of the game board include a soft surface that can be rolled or folded, and sand with the playing positions marked in the sand.

The invention may include means for securing a playing piece in that playing position to resist inadvertent movement of the playing pieces.

The present invention additionally comprises several variations in the configuration of the playing board, the number of playing pieces, and the Rules of the Game. There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of claims.

An advantage of the present invention is that it provides a simple board game, with few rules, that is challenging and interesting to a broad range of players.

A second advantage of the present invention is that it provides a competitive board game emphasizing strategy, intelligence, and flexible tactics.

Another advantage of the present invention is that it provides a board game where the winning player attains a goal not related to jumping, capture, or scoring over or against an opponent. A player wins by attaining a winning alignment before the opponent attains such an alignment.

Yet another advantage of the present invention is that it provides a game that can be played by players a wide variety of physical abilities.

Still another advantage of the invention is that it provides a game that can be played by players having a wide variety of ages.

A further advantage of the present invention is that it provides a board game that allows variations in the playing board and game pieces to provide players with variety in the game.

The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

These and other features, aspects, and advantages of the present invention will become better understood with regard to the following description, appended claims, and accompanying drawings where:

FIG. 1 is a perspective view that illustrates a version of the invention in the starting configuration, and illustrates certain Rules of the Game governing movement of the playing pieces.

FIG. 2 illustrates a version of the invention with a winning configuration.

FIG. 3 illustrates a version of the invention with another winning configuration.

FIG. 4 illustrates a version of the invention with another winning configuration.

FIG. 5 illustrates a version of the invention with another winning configuration.

### BEST MODE OF CARRYING OUT THE INVENTION

Turning now to the drawings, the invention will be described in preferred embodiments by reference to the numerals of the drawing figures wherein like numbers indicate like parts. The preferred embodiment of the Dao Game comprises a playing surface, eight playing pieces in two sets of four, each set distinguishable from the other set, and the Rules of the Game.

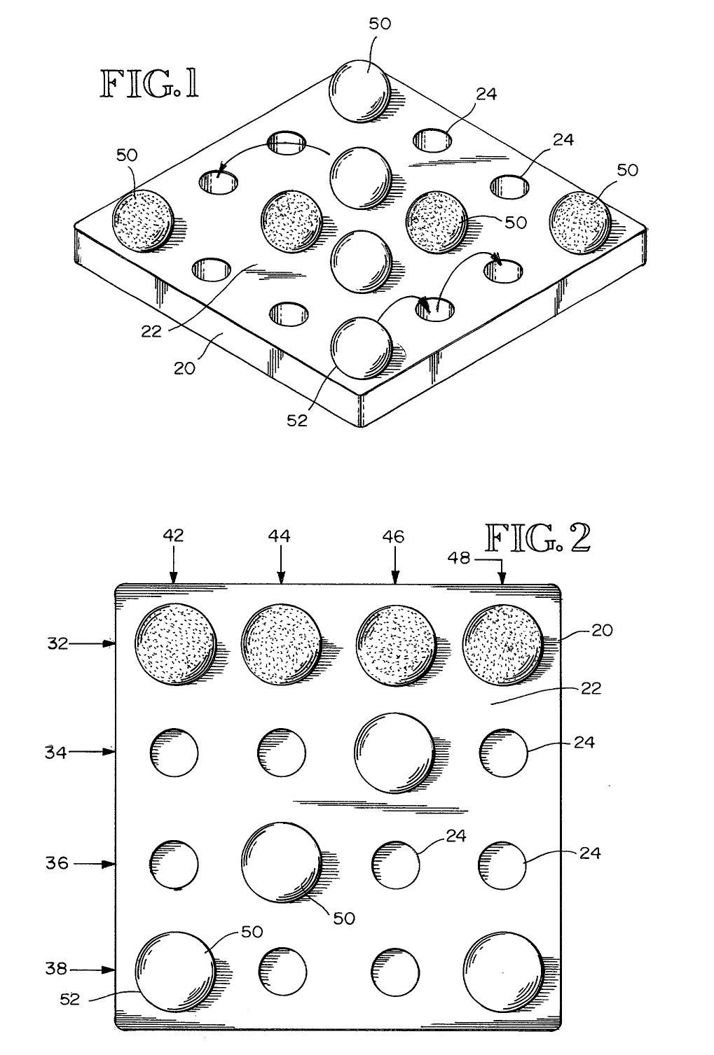

FIG. 1 generally illustrates the general arrangement of the playing board in the preferred embodiment. The playing board, shown generally as 20, is provided with one playing area shown at 22. The playing area is comprised of rows and columns of playing positions arranged in a four-by-four square grid as shown in FIG. 2. The playing board can be made from any suitable material such as molded plastic, flexible sheet, or tile.

FIGS. 1 and 2 illustrates the relative locations of playing positions in the preferred embodiment of the invention. The playing positions are generally arranged in a square grid, represented by circles, and shown generally at 24 in FIG. 2. The playing positions are arranged in adjacent rows shown as 32, 34, 36, and 38, and in adjacent columns shown as 42, 44, 46, and 48, all in FIG. 2. The playing positions may take any form that identifies them as such on the surface of the playing board. Some of the forms of identifying playing positions, as contemplated in the present invention, are: regions of contrasting color on the playing board; shallow depressions in the surface of the playing board; holes cut at least partially through the thickness of the playing board; or pieces of hook and loop fastener that are attached to the surface of the playing board.

For esthetic reasons, and to facilitate play, the rows are preferably uniformly spaced, and disposed symmetrically. The playing positions, shown as 24, are represented by circles, and the playing pieces, shown as 50, are represented as balls. This does not imply that the playing positions and the playing pieces are necessarily in those shapes. In one embodiment of the present invention, the playing pieces are substantially spherical solids and the playing positions are mating spherical depressions in the playing board. Any other desired shape may be used, within the intended scope of the present invention.

In an alternative embodiment, the location of each playing position can be related to the location(s) of one or more other playing positions by some convenient visual or tactile means. A simple means for identifying such relationships is a line of contrasting color on the surface 22 of the playing board 20, and the term line is used herein to encompass all such means. Other appropriate means contemplated in the present invention include grooves or raised ridges on the surface of the playing board. Either of these means could be combined with contrasting color to identify the relationship between playing positions. If desired, additional lines may be employed.

Playing pieces may be any desired shape and size that allow them to be conveniently picked up and moved by the players during play. FIGS. 1 and 2 illustrate spherical playing pieces in the preferred embodiment of the invention. The pieces are designed to mate with the playing positions. For example, if the playing positions 24 are identified by sphere like depressions in the playing surface 22, the playing pieces 50 should be spheres mating with the spherical depressions. The use of magnets, or depressions, on the surface of the playing board allows the playing pieces to remain where placed by the players, avoiding unintentional movement should the playing board be jarred or accidentally moved during play.

For the board game illustrated in FIGS. 1 and 2, eight playing pieces are required. The characteristics of the playing pieces lend themselves to variations including being representative of themes to make the game more appealing to players of certain interests, groups, or cultures. ;For visually and physically impaired players, an alternative embodiment of the playing pieces includes tactile or audible marking to identify which player the pieces belong to, including but not limited to different sizes of the same piece configuration, sound generating apparatus in the piece, and raised markings on the piece.

The characteristics of the playing pieces may comprise any distinguishable characteristic which may be ascertained visually, by touch, or by sound when shaken. The distinguishable characteristic shown in FIGS. 1 and 2 is color. The first set of pieces are dark colored spheres, and the second set are light colored spheres. Alternative embodiments of the playing pieces include all tactilely and visually distinctive characteristics of shape, color, and texture. The playing pieces may also be different colors. Alternative embodiments of the playing pieces could also be predicated upon physical shape or other recognizable formats, including Buddha, totem pole, ball, and crystal. Any theme could be indicated on the pieces which relate to themes appropriate to adults, children, or a preference of a particular playing group. For example, the playing pieces could be two colors of flat tiles, each with the likeness of Buddha on the top surface. For blind or visually impaired players, the pieces could have a theme that is easily distinguished by touch.

The nature of the game makes it easily adaptable for play on a computer. For example, a computer may be programmed with suitable algorithms to respond to a player's moves, thereby allowing a single player to compete against the computer. A computer may also be programed to display the playing board and playing pieces on its monitor while the computer keeps track of the location of each playing piece. A player could use an input device such as a mouse or joystick to tell the computer which pieces are to be moved, and to which new playing positions, thereby allowing two players to compete against each other.

The apparatus for the board game of the present invention, illustrated in the drawings, was devised concurrently with a method for playing the game. It is the intent of the inventors that the apparatus and the method are inseparable. The method for playing the game may be termed Rules of the Game.

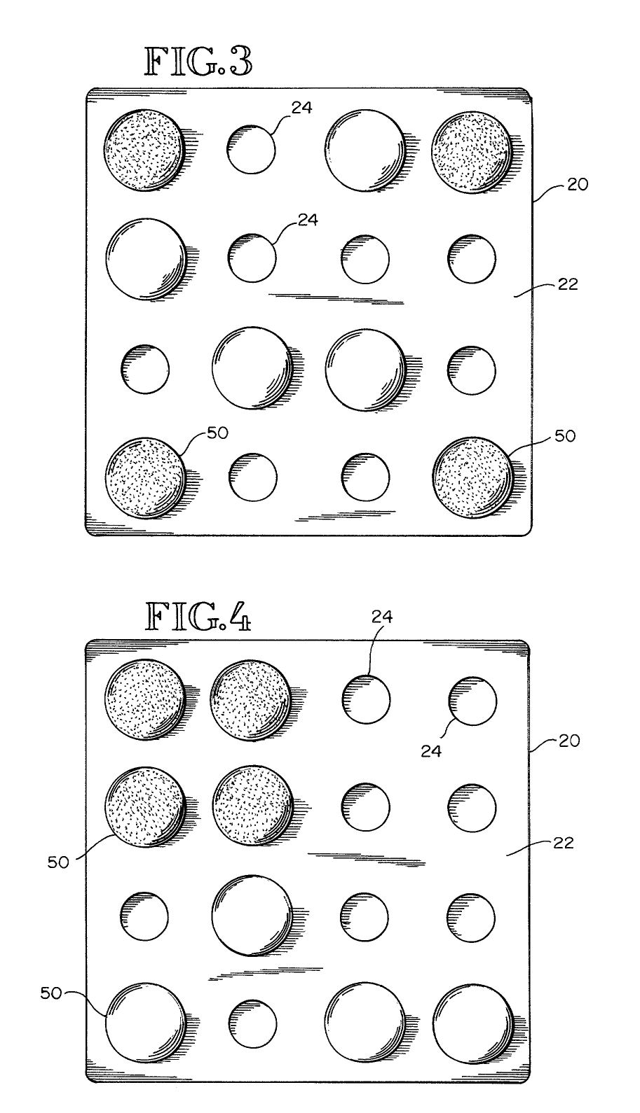

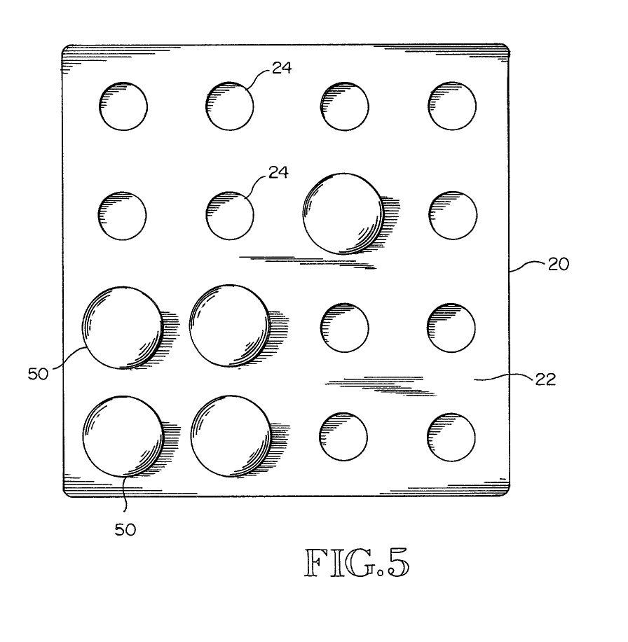

Two terms used in the Rules of the Game warrants specific definition. The first term is “open position.” As applied to a playing piece, the term “open position” means the unoccupied playing positions lying immediately adjacent in either a row, column, or diagonal from the playing piece. For example, FIG. 2 shows playing piece 52 in row/column 38/42. For playing piece 52, playing positions 36/42 and 34/42 are open positions in column 42, and playing positions 38/44 and 38/46 are open positions in row 38. For playing piece 52, there are no diagonal playing positions open because another playing piece occupies playing position 36/44. The second term is “winning configuration.” In FIGS. 2-5, the playing pieces of the winning player are indicated with shading on the sphere. As applied to the game, winning configuration means (i) forming any straight line with all of a player's pieces as shown in FIG. 2, not including diagonal; (ii) occupying the four corners of the board at the same time as shown in FIG. 3; (iii) arranging all of the player's pieces into a square as shown in FIG. 4; and (iv) when the player has any one playing piece blocked in a corner by three pieces of the other player as shown in FIG. 5.

The Rules of the Game are as follows:

a. This is a game for two players, one of whom may be a computer;

b. To start the game, the playing pieces are placed in the starting configuration. The starting configuration is an “X” with each player's pieces forming one leg of the “X” aligned diagonally from the corners. FIG. 1 illustrates the starting configuration. The arrows on FIG. 1 depict an open position move from the starting configuration for playing piece 52.

c. One of the players, selected by chance, begins play by moving one playing piece assigned to that player from the starting configuration to any open position.

d. In completing a move, the move must be in a straight line, and as far as possible until the playing piece reaches the end of the playing area or another piece. For example, a player may not move only one space if two spaces are open in the same direction.

e. In completing a move, a playing piece cannot move over another piece or to a position already occupied.

f. After one player has completed a move, the other player makes a move;

g. The players continue to alternate moves until one player attains a winning configuration. That player is the winner.

Numerous variations in Rules of the Game are possible. For example, the winning positions could be modified so that a player who blocks the other's playing piece in a corner as shown in FIG. 5 is the winner instead of the loser.

The board game of the present invention may be enclosed within a case. In this mode, the playing board and playing pieces may be conveniently stored within a protective case to avoid loss or damage.

This preferred embodiment of the invention is complex enough to be challenging, yet simple enough to provide speedy games. However, numerous other methods of play, fully within the spirit and intent of the present invention, could be devised could be devised by those of ordinary skill in the art. Therefore, it is intended that the foregoing detailed description be regarded as illustrative, rather than limiting.

### INDUSTRIAL APPLICABILITY

The invention has applicability to the field of board games for two people. In compliance with the statute, the invention has been described in language more or less specific as to structural features.

It is to be understood, however, that the invention is not limited in its application to the details of construction, to the arrangements of the components set forth in the following description or illustrated in the drawings, and the Rules of the Game. The invention is capable of other embodiments and of being practiced and carried out in various ways. As such, it will be readily apparent to those skilled in the art that the conception, upon which this disclosure is based, may readily be utilized as a basis for the designing of other structures, methods and systems for carrying out the several purposes of the present invention.

Therefore the invention should not be construed as being limited to phraseology and terminology used to describe it herein. The invention is claimed in any of its forms or modifications within the legitimate and valid scope of the appended claims, appropriately interpreted in accordance with the doctrine of equivalents.

What is claimed is:

1. A board game comprising:
a. a surface with a playing area having sixteen playing positions arranged in a four-by-four grid;
b. eight playing pieces in two sets of four, each of said sets distinguishable from the other; and
c. rules of the game.

2. The board game of claim 1 wherein said playing pieces, said playing area, said rules of the game, and said playing positions all exist as data within a computer, and wherein at least a portion of said data is displayed on an output means.

3. The board game of claim 2 wherein said computer is programed to play against a human opponent.

4. The board game of claim 2 wherein said computer is programed to allow two players to compete against each other while said computer keeps track of the locations of said playing pieces.

5. The board game of claim 1 wherein said game additionally comprises printed matter setting forth a method of play therefor, and said method of play is said rules of the game.

6. A method for playing a board game comprising:
a. providing a playing surface with a playing area having sixteen playing positions arranged in a four-by-four grid;
b. providing eight playing pieces in two sets of four, each of said sets distinguishable from the other;
c. providing two players, one of whom may be a computer;
d. assigning each of said two players one of said sets of said playing pieces;
e. placing said playing pieces on said playing surface in the starting configuration, wherein said starting configuration is an “X” with each of said player's pieces forming one leg of said “X” aligned diagonally from the corners of said playing surface;
f. selecting a first player, who begins play by moving one of said playing pieces assigned to that player from said starting configuration to any one of said playing positions, subject to the provision that in completing a move, said move must in a straight line, and said one of said playing pieces must be moved as far as possible until said one of said playing pieces reaches the end of said playing area or another of said playing pieces, and further subject to the provision that in completing said move, said one of said playing pieces cannot be moved over another of said playing pieces or to one of said playing positions that is already occupied by another of said playing pieces;
g. selecting a second player who continues play by making a move subject to the same conditions of said move of said first player;
h. continuing play during which said first player and said second player, in alternating turns, make moves until one player is declared the winner; and
i. declaring said winner to be the player who aligns his or her playing pieces to:
i. form any straight line except a diagonal line;
ii. occupy all of said playing positions in the corners of said playing surface at the same time;
iii. form a square configuration with all of said winner's playing pieces adjacent to each other; or
iv. have any one of said winner's playing piece blocked in any one of said playing positions at said corners of said playing surface by three of said playing pieces of the other player.

7. The method of claim 5 wherein said playing pieces, said playing area, said rules of the game, and said playing positions all exist as data within a computer, and wherein at least a portion of said data is displayed on an output means.

8. The method of claim 6 wherein said computer is programed to play against a human opponent.

9. The method of claim 6 wherein said computer is programed to allow two players to compete against each other while said computer keeps track of the locations of said playing pieces.
